(19) United States
(12) Patent Application Publication
(10) Pub. No.: US 2014/0215632 A1
(43) Pub. Date: Jul. 31, 2014

(54) PREVENTING THE DETECTION AND THEFT OF USER ENTRY ALPHANUMERIC SECURITY CODES ON COMPUTER TOUCH SCREEN KEYPADS

(71) Applicant: INTERNATIONAL BUSINESS MACHINES CORPORATION, (US)

(72) Inventors: Darryl M. Adderly, Morrisville, NC (US); Prasad Kashyap, Cary, NC (US); Brian J. Murray, Raleigh, NC (US); Wenjian Qiao, Cary, NC (US)

(73) Assignee: INTERNATIONAL BUSINESS MACHINE CORPORATION, Armonk, NY (US)

(21) Appl. No.: 13/752,740

(22) Filed: Jan. 29, 2013

(51) Int. Cl. G06F 21/60

(52) U.S. Cl. CPC G06F 21/604
USPC 726/26

(57) ABSTRACT

Preventing, discernible patterns of surface marks resulting from the repetitive entry of security codes to computer device touch screen alphanumeric keypads. There is predetermined the number of security code entries after which the positions of the representative keys in the keypad array should be reconfigured. This predetermined number should be the number of security code entries estimated to produce a pattern of distinguishable display surface marks coincident with a users repetitive entry alphanumeric character security code. The number of security code entries is counted. When the count of the predetermined number of security code entries has been reached, the representative keys in the displayed keypad array are reconfigured. This implementation is equally effective against thieves who are visually stealing the security codes over the user's shoulder.

### TECHNICAL FIELD

The present invention relates to the protection of alphanumeric security codes entered by a user on the touch screen keypad of the user's computer display, and particularly the user's handheld devices, e.g. “Iphones” or “Ipads.”

### BACKGROUND OF RELATED ART

With the rapidly increasing availability of data storage space and the increasing speed of data processing transactions, all of a user's data storage distribution is becoming ever more widespread. Now with Cloud Computing, the storage of a user's data may be almost infinitely distributed, only to be brought together as required, at the user's fingertips on the user's display screen. Of course, such a reconstitution of widely stored data is responsive to the user's entry of an alphanumeric security code through the user's alphanumeric keypad array displayed on the user's handheld touch screen display.

Needless to say, with such a distribution of user data there will be widespread worldwide networks of computer data thieves. These vary from hackers and phishers who try to steal data from the user at data entry levels to masterminds who work to intrude into major governmental, banking and industrial databases. Because of the worldwide distribution of these data thieves, restitution is difficult even if the crimes are solved because these criminal operatives frequently operate outside of the jurisdictions where the data and the resulting capital and personal data losses occur.

Of course, there are extensive and comprehensive worldwide security protective systems for the security of the banking, governmental, industrial, military and educational institutions. However, very often simplistic hacking at the user level easily obtains a user's security data. For example, it is known that hackers use publicly available information to decipher alphanumeric information memorable to the user that may find its way into the user's security codes. Thus, a user has to be alert to even the user's own apparently unimportant repetitive habits to avoid the potential hacking data thieves who may be lurking.

The present invention has recognized such repetitive habits of an unsuspecting user that can readily provide an intrusive hacker with information needed to completely access the user's data. As a result, the invention has provided a solution to oversights of a user and provides a relatively foolproof implementation that will protect even the most unsophisticated users from theft of their security codes.

### SUMMARY OF THE PRESENT INVENTION

The present invention is directed toward the elimination of discernible patterns of surface marks on user display screens that will coincide with the position patterns in the keypad array wherein repeated entry of the user's alphanumeric security codes has caused wear or smudge marks that will expose the security code to an intruder.

Accordingly, the present invention provides an implementation for preventing discernible patterns of surface marks resulting from repetitive entry of security codes to computer device touch screen alphanumeric keypads in a displayed keypad array of keys, each representing an alphanumeric character for the entry of alphanumeric data on a device touch screen. There is predetermined the number of security code entries after which the positions of the representative keys in the keypad array should be reconfigured. This predetermined number should be the number of security code entries estimated to produce a pattern of distinguishable display surface marks coincident with a user's repetitive entry alphanumeric character security code. The number of security code entries is counted. Then when the count of this predetermined number of security code entries has been reached, the representative keys in said displayed keypad array are reconfigured.

The predetermined number of entries may be a single entry, i.e. every time a user “signs in” through the key security entry, the keyboard array is reconfigured so that even though the user is entering the same sequence of alphanumeric character's, these characters will be in different positions on the display screen. Accordingly, marks or smudges in the same character positions are avoided. However, even if there are smudges left, they would be all over the screen and their entry pattern not discernible.

In reconfiguration, the keys in a keypad array need not be moved. The positions of the keys in the array may remain unchanged but the alphanumeric characters represented by said keys are changed.

In the reconfiguration, a keypad array may be changed so that the keys in the array are repositioned on the display screen. Also, the keypad array may be repetitively reconfigured between regular and irregular array patterns. In accordance with another aspect of the invention, each key in said displayed array has a different color. There is a displayed legend wherein each key color represents an alphanumeric character, and in the reconfiguring, the representative keys in said displayed keypad array are reconfigured by changing the legend wherein the colors representing said alphanumeric characters are changed.

While the description here and above, and subsequent descriptions of the embodiment of the invention, presents examples of surface marks resulting from the entry of security codes, the invention is equally applicable from preventing the theft of security codes by directly stealing a view of the user entering the code.

It should be understood that wherever references are made to colors of entry keys provision may also be provided for individuals who are “color blind.” In such circumstances, the colors may be replaced by different graphic patterns for keys that will be used in place of colors.

### BRIEF DESCRIPTION OF THE DRAWINGS

The present invention will be better understood and it's numerous objectives and advantages will become more apparent to those skilled in the art by reference to the following drawings, in conjunction with the accompanying specification, in which:

FIG. 1 is a generalized diagrammatic view of a typical handheld computer with a displayed alphanumeric keypad wherein a user security code may be entered;

FIG. 2 is the display computer of FIG. 1 wherein the keypad has been reconfigured so that the keys now represent alphanumeric characters different in position from the keypad of FIG. 1;

FIG. 3 is the display computer of FIG. 1 wherein the keypad has been reconfigured so that the keypad columns have been shifted into an irregular pattern;

FIG. 4 is the display computer of FIG. 1, wherein each key in said displayed array has a different color, there is a displayed legend wherein each key color represents an alphanumeric character, and in the reconfiguring, the representative keys in the displayed keypad array are reconfigured by changing the legend wherein the colors representing the alphanumeric characters are changed while the displayed array remains unchanged;

FIG. 5 is an illustrative diagrammatic view of a computer system that may be used in a display computer in this invention;

FIG. 6 is a general flowchart of a program set up to implement the present invention for preventing discernible patterns of surface marks resulting from repetitive entries of user security codes; and

FIG. 7 is a flowchart of an illustrative run of the program set up in FIG. 6.

### DETAILED DESCRIPTION OF THE PREFERRED EMBODIMENT

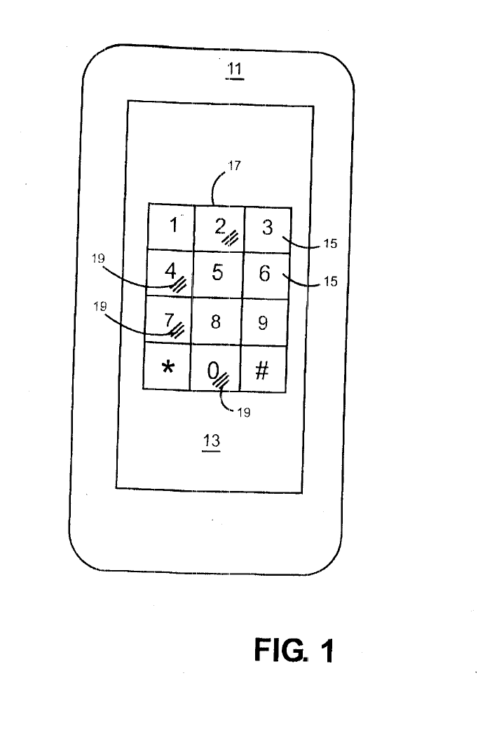

Referring to FIG. 1, there is shown a generalized diagrammatic view of a typical handheld computer with a displayed alphanumeric keypad wherein a user security code has been entered. Display screen 13 on computer 11 has a keypad. array 17 of keys 15 arranged in regular rows and columns. In normal usage, the user's security code of the alphanumeric characters: “2-4-7-0” a corresponding pattern of smudges 19 results from repeated entry. These would be discernible to the naked eye of an intruder who has access and can examine the screen surface of keypad 17. However, even after a single entry of the user's entry code, there is “snooping” equipment, such as light reflection off surfaces, wherein a single input may be detectable. In any event, on most screen surfaces, a discernible pattern of keypad wear may require the entry of a security code several times. Thus, the system may count the number of times that the user security code has been entered until a predetermined number of such entries have been made. Dependent on the circumstances of usage, the user may predetermine the number of security code entries to be made before the keypad is reconfigured.

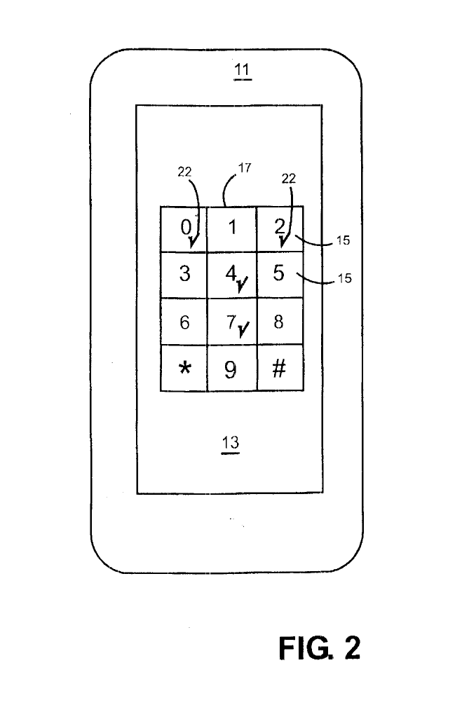

When the count of security code entries reaches the predetermined number, the keypad array is reconfigured. This reconfiguration may be as simple as that shown in FIG. 2, wherein the keypad itself is not moved or shifted in any way except that the key that represents the respective characters are shifted one increment. As a result, when the same security entry code “2-4-7-0” is entered on the keys of the keypad, the keys touched, shown by check marks 22, will have four positions that are different from the positions of the same security code as entered in FIG. 1. Accordingly, if the representation of the keys are periodically reconfigured, there can be no repetitive smudge or mark patterns. There may be many smudges and marks in the keypad area but nothing discernible; subsequent entries will in effect camouflage the prior security code entries.

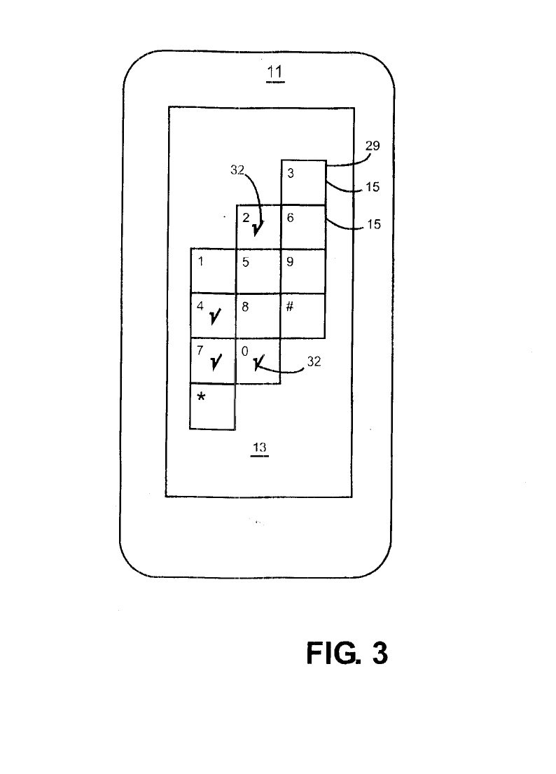

FIG. 3 is another example of a keypad reconfiguration in accordance with the present invention, wherein the actual keypad array layout structure is changed from the regular layout 17 of FIG. 1 to the irregular layout 29. Here again, the security code entry input “2-4-7-0” will result in a pattern, as indicated by checkmarks 32, which does not coincide with the security input of FIG. 1. Thus, wear and marks caused by repetitive touching of the keys in the keypad is avoided.

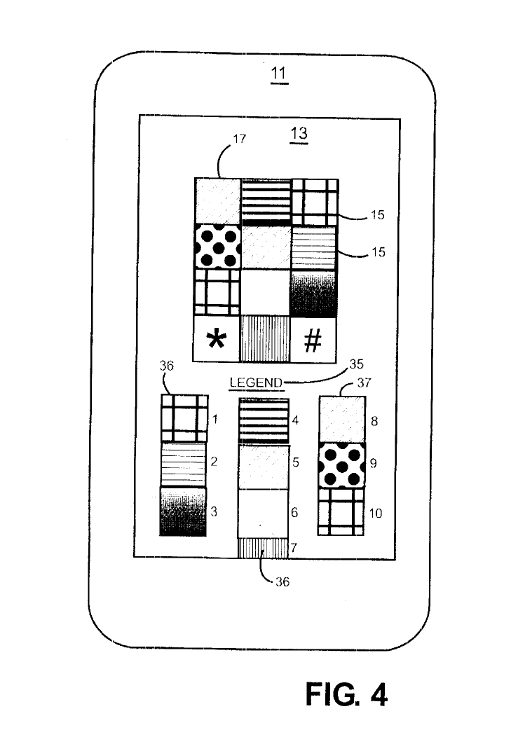

Another aspect of the present invention is shown in FIG. 4. In this embodiment, all of the keys 15 in keypad 17 have different colors as indicated by the different markings on each key. The colors of the keys are never changed and the positions of the keys are never changed. However, there is a displayed legend 35 showing the columns 36, 37 and 38 of colors and the alphanumeric characters represented by each color appears alongside of the respective color. With this embodiment, when entering the security code, the user checks the legend to see what color represents each of the entry code “2-4-7-0.” When a reconfiguration is needed, the legend is changed.

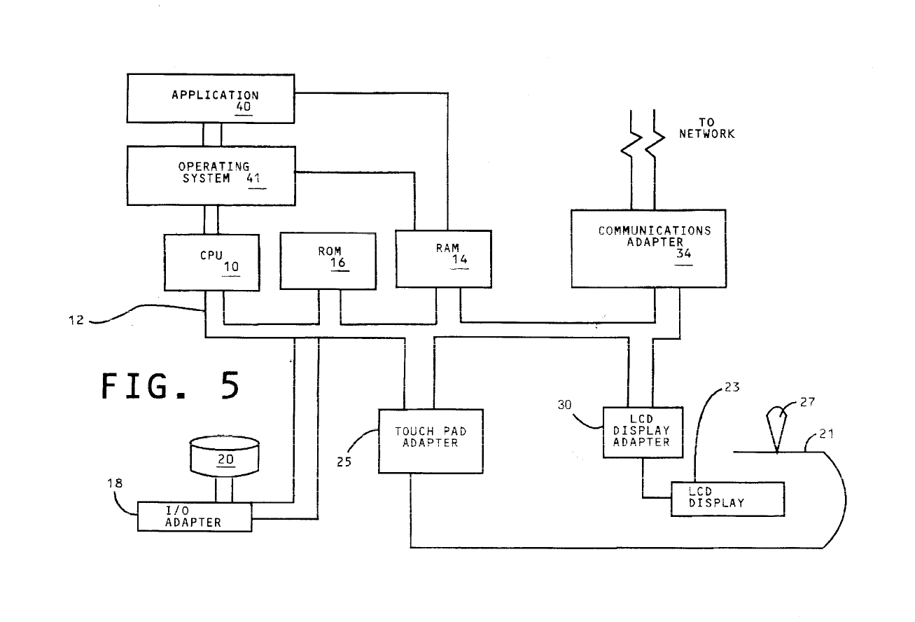

Referring now to FIG. 5, there is shown an illustrative diagrammatic view of a computer system that may be used in a display computer in this invention. The illustrative device has a computer controlled LCD display. There is a CPU 10 that is connected to the system components by bus 12. An operating system 41 runs on CPU 10 and coordinates the various system components, including touch screen 21 and LCD display pad 23. The programs of the present invention for reconfiguring the keys in the keypad, as shown in FIGS. 1 through 4, which is among the applications 40 runs in conjunction with operating system 41 to perform the reconfiguration function of the present invention. A read only memory (ROM) 16 id connected to CPU 10 via bus 12 and includes the computer system BIOS that controls basic computer functions. Random Access Memory (RAM) 14, I/O adapter 18 and communication adapter 14 are also interconnected to system bus 12. When the system is dormant, most of the software, including operating system 41 and applications 40 are stored in disk storage device 20. I/O adapter 18 connects with storage device 20. Communication adapter 34 interconnects bus 12 with outside networks. With respect to the touch screen devices used in the present invention, all conventional touch screen devices may be used. Typically, there is an LCD display having a surface 23 upon which visual output from the computer via LCD display adapter 30. A touch sensitive screen is superimposed above display surface 23. This touch screen is sensitive to the touch of stylus or finger 27. The touch screen 21 resolution is maintained by digital circuitry in a touch screen adapter to form a two (2) dimensional array of discrete coordinate points. A touch stimulus applied by finger 27 to any of the coordinate points is detected by a sensor array (not shown). This touch data together with the coordinates to which the touch relates are transmitted from touch screen to the touch pad adapter 25. In turn, the data is transmitted to CPU 10 and operating system 41 wherein the input is applied to display 23 via display adapter 30.

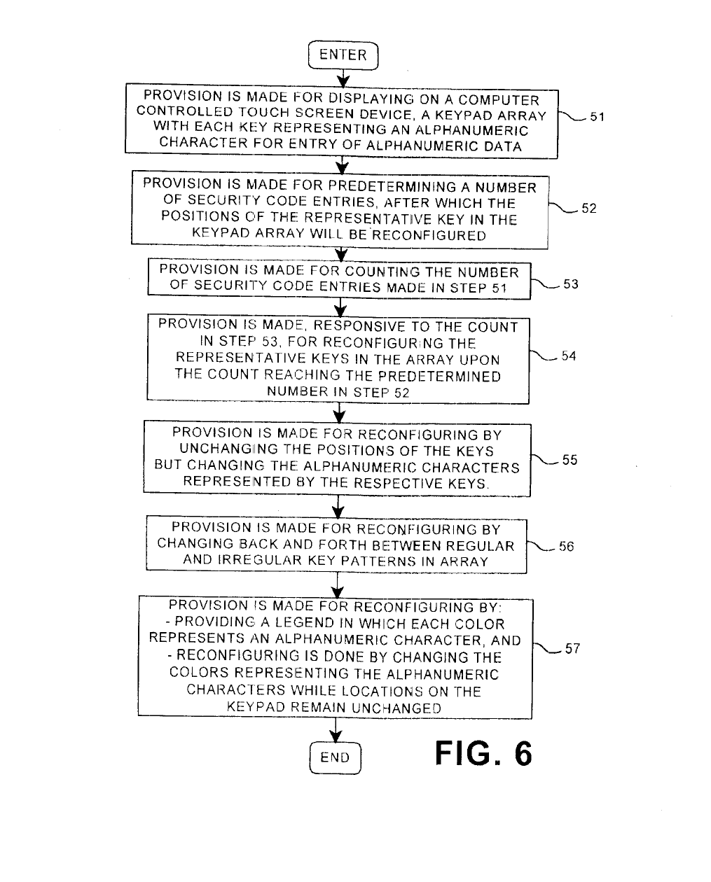

Now with respect to FIG. 6, a general flowchart of a program set up to implement the present invention for preventing discernible patterns of surface marks resulting from repetitive entries of user security codes will be described. Provision is made for displaying on a computer controlled touch screen, a keypad array with each key representing an alphanumeric character in the entry of alphanumeric data step 51. Provision is made for predetermining a number of security code entries, after which the positions of the representative keys in the keypad array will be reconfigured, step 52.

Provision is made, step 53, for then counting the number of security code entries made in step 51. Provision is made, responsive to the count in step 53, for reconfiguring the representative keys in the array upon the count reaching the predetermined number, step 54. In accordance with one way of reconfiguring, step 55, provision is made by not changing the positions of the keys but rather changing the alphanumeric characters. Provision may be made for reconfiguring iterations involving changing back and forth between, by going from regular to irregular keypad array patterns, step 56.

In accordance with another aspect of the invention, provision is made for reconfiguring by displaying a legend in which each color represents an alphanumeric character, arid then reconfiguring is done by changing the colors representing the respective alphanumeric characters while the locations on the keypad remain unchanged, step 57.

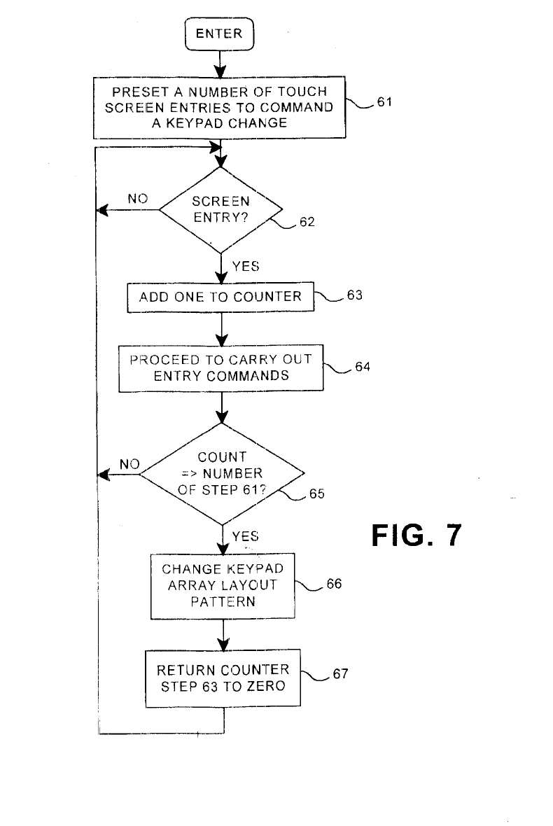

A simple illustrative example of a run of the process set up in FIG. 6 is described with respect to the flowchart of FIG. 7. The user presets a number of touch screen entries that must be reached before there is a reconfiguration of the keypad keys, step 61. This number should be chosen based upon the circumstances of use. For example, with a relatively sensitive touch screen surface, the user may wish to reconfigure the keypad arrangement after every new entry of a security code. Likewise, if the protected data is highly sensitive, a change upon a new security code entry may also be warranted. Step 62, a determination is made as to whether there has been an entry of a security code on the keypad. If No, the entry is awaited. If Yes, one is added to the counter tracking the number of keyboard entries, step 63. After the entry, the computer is activated to be used to process I/O data, step 64, and a determination is made, step 65, as to whether the count of security code entries equals the preset number of entries set in step 61. If No, the process is returned to step 62. If the determination in step 65 is Yes, then the keypad layout pattern is reconfigured, step 66, and the counter returned to “zero”, step 67. At this point, the process is returned to step 62, wherein the next security code entry is awaited.

As will be appreciated by one skilled in the art, aspects of the present invention may be embodied as a system, method or computer program product. Accordingly, aspects of the present invention may take the form of an entirely hardware embodiment, an entirely software embodiment, including firmware, resident software, micro-code, etc.; or an embodiment combining software and hardware aspects that may all generally be referred to herein as a “circuit”, “module” or “system.” Furthermore, aspects of the present invention may take the form of a computer program product embodied in one or more computer readable mediums having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a RAM, a ROM, an Erasable Programmable Read Only Memory (“EPROM” or Flash memory), an optical fiber, a portable compact disc read only memory (“CD-ROM”), an optical storage device, a magnetic storage device or any suitable combination of the foregoing. In the context of this document, a computer readable storage medium may be any tangible medium that can contain or store a program for use by or in connection with an instruction execution system, apparatus or device.

A computer readable medium may include a propagated data signal with computer readable program code embodied therein, for example, in baseband or as part of a carrier wave. Such a propagated signal may take any of a variety of forms, including, but not limited to, electromagnetic, optical or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including, but not limited to, wireless, wire line, optical fiber cable, RF, etc., or any suitable combination the foregoing.

Computer program code for carrying out operations for aspects of the present invention may be written in any combination of one or more programming languages, including an object oriented programming language, such as Java, Smalltalk, C++ and the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the later scenario, the remote computer may be connected to the user's computer through any type of network, including a local area network (“LAN”) or a wide area network (“WAN”), or the connection may be made to an external computer (for example, through the Internet, using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality and operations of possible implementations of systems, methods and computer program products according to various embodiments of the present invention. In this regard, each block in the flowchart or block diagrams may represent a module segment, or portion of code, which comprises one or more executable instructions for implementing the specified logical function(s). It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations can be implemented by special purpose hardware-based systems that perform the specified functions or acts, or combinations of special purpose hardware and computer instructions.

Although certain preferred embodiments have been shown and described, it will be understood that many changes and modifications may be made therein without departing from the scope and intent of the appended claims.

What is claimed is:

1. A method for preventing discernible patterns of surface marks resulting from repetitive entry of security codes to computer device touch screen alphanumeric keypads comprising:
displaying a keypad array of keys, each representing an alphanumeric character for the entry of alphanumeric data on a device touch screen;
predetermining a number of security code entries, after which the positions of the representative keys in the keypad array will be reconfigured;
counting the number of security code entries; and
responsive to a count that said predetermined number has been reached, reconfiguring the representative keys in said displayed keypad array.

2. The method of claim 1, wherein the predetermined number of entries is a single entry.

3. The method of claim 1, wherein said keypad array is reconfigured so that the positions of the keys in the array remain unchanged but the alphanumeric character represented by a key is changed.

4. The method of claim 1, wherein said keypad array is reconfigured so that the keys in the array are repositioned on the display screen.

5. The method of claim 4, wherein said keypad array is repetitively reconfigured between regular and irregular array patterns.

6. The method of claim 1, wherein each key in said displayed array has a different color.

7. The method of claim 6, further including:
displaying a legend wherein each key color represents an alphanumeric character; and
reconfiguring the representative keys in said displayed keypad array by changing the legend wherein the colors representing said alphanumeric characters are changed.

8. A computer controlled system for preventing discernible patterns of surface marks resulting from repetitive entry of security codes to computer device touch screen alphanumeric keypads comprising:
a processor; and
a computer memory holding computer program instructions that when executed by the processor perform the method comprising:
displaying a keypad array of keys, each representing an alphanumeric character for the entry of alphanumeric data on a device touch screen;
predetermining a number of security code entries after which the positions of the representative keys in the keypad array will be reconfigured;
counting the number of security code entries; and
responsive to a count that said predetermined number has been reached, reconfiguring the representative keys in said displayed keypad array.

9. The system of claim 8, wherein the predetermined number of entries is a single entry.

10. The system of claim 8, wherein said keypad array is reconfigured so that the positions of the keys in the array remain unchanged but the alphanumeric character represented by a key is changed.

11. The system of claim 8, wherein said keypad array is reconfigured so that the keys in the array are repositioned on the display screen.

12. The system of claim 11, wherein the performed method repetitively reconfigures said keypad array between regular and irregular array patterns.

13. The system of claim 8, wherein each key in said displayed array has a different color.

14. The system of claim 13, wherein said performed method further includes:
displaying a legend wherein each key color represents an alphanumeric character; and
reconfiguring the representative keys in said displayed keypad array by changing the legend wherein the colors representing said alphanumeric characters are changed.

15. A computer usable storage medium having stored thereon a computer readable program for preventing discernible patterns of surface marks resulting from repetitive entry of security codes to computer device touch screen alphanumeric keypads, wherein the computer readable program when executed on a computer causes the computer to:
display a keypad array of keys, each representing an alphanumeric character for the entry of alphanumeric data on a device touch screen;
predetermine a number of security code entries after which the positions of the representative keys in the keypad array will be reconfigured;
count the number of security code entries; and
responsive to a count that said predetermined number has been reached, reconfigure the representative keys in said displayed keypad array.

16. The computer usable storage medium of claim 15 wherein the predetermined number of entries is a single entry.

17. The computer usable storage medium of claim 15, wherein the computer program when executed reconfigures said keypad array so that the positions of the keys in the array remain unchanged but the alphanumeric character represented by a key is changed.

18. The computer usable storage medium of claim 15, wherein the computer program when executed reconfigures said keypad array so that the keys in the array are repositioned on the display screen.

19. The computer usable storage medium of claim 18, wherein the computer program when executed repetitively reconfigures said keypad array between regular and irregular array patterns.

20. The computer usable storage medium of claim 15, wherein each key in said displayed array has a different color.

21. The computer usable storage medium of claim 20, wherein the computer program when executed further causes the computer to:
display a legend wherein each key color represents an alphanumeric character; and
reconfigure the representative keys in said displayed keypad array by changing the legend wherein the colors representing said alphanumeric characters are changed.

22. A computer controlled device with a touch screen for the repetitive entry of security codes comprising:
a displayed reconfigurable touch keypad for entry of security codes including a set of alphanumeric characters;
a counter for counting the number of entries of said security code; and
a trigger for reconfiguring the displayed touch keypad responsive to a predetermined count in said counter.

23. The device of claim 22, wherein said predetermined count of entries is a single entry.

24. The device of claim 23, wherein said reconfigured keypad array includes the unchanged positions of the keys in the array but the alphanumeric characters represented by said keys changed.

25. The device of claim 22, wherein said keypad array is reconfigured so that the keys in the array are repositioned on the display screen.

26. The device of claim 22, wherein each key in said displayed array has a different color.

27. The device of claim 26, wherein said display further includes:
a displayed legend wherein each key color represents an alphanumeric character, wherein the representative keys in said displayed keypad array are reconfigured by changing the legend wherein the colors representing said alphanumeric characters are changed.
